(19) United States
(12) Patent Application Publication
(10) Pub. No.: US 2007/0055631 A1
(43) Pub. Date: Mar. 8, 2007

(54) Copy right protecting digital publishing system

(76) Inventor: Fred T. Li, Taipei (TW)

Correspondence Address: HDSL, 4331 STEVENS BATTLE LANE, FAIRFAX, VA, 22033, US

(21) Appl. No.: 11/217,306

(22) Filed: Sep. 2, 2005

(51) Int. Cl. G06F 17/60

(52) U.S. Cl. 705/57

(57) ABSTRACT

The application concerns a digital publishing system that prevents piracy and protects the intellectual property rights of authors and publishers, using the encryption-decryption techniques developed for the financial industry. The system includes the following: A DigiReader, a DigiBookstore, a PubNetmanager and a DigiGuard. Use of the system will replace the current paper-based publishing of books.

### BACKGROUND OF THE INVENTION

1. Field of the invention

The invention concerns a digital publishing system that protects the intellectual property rights. In particular, it concerns a system that complies with existing business flows and uses the encryption-decryption technologies developed for the financial industry to prevent piracy and protect the copy rights of authors and publishers.

2. Description of the prior art

Publishers of today all uses digital technologies in the production of books. The book contents are stored in databases and are the major assets of the publisher. The publishers are reluctant to release high value digital content to others for storage. During publication, publishers, at the expense of much resource, print these contents on paper to make books. For areas that traditional paper books cannot convey, e.g. foreign language pronunciations and dynamic graphics, publishers frequently store them in a compact disk in digital form for readers to retrieve with a computer. These publication flows impose tremendous cost to the publishers and inconveniences to consumers.

In the earlier days, people built dedicated devices to display the contents and asked publishers to store their contents with the service provider for customers to download from the Internet. In the first place, publishers are reluctant to store their high-value content, their major asset, with others. On the other hand, the devices were expensive and not well built. Consumer did not buy into the plan and the efforts were abandoned.

The next is the ebooks, digital files of contents of books, accessible with a computer from the Internet. Since most of the readers already own a computer, the cost of an extra device can be eliminated. In order to avoid loss of availability of the content during a computer crash, providers usually offer accesses to more than one computer, thus, effectively making available duplicate content to non-paying users. On account of the lack of intellectual property right protection, publishers are even less willing to put their high-value contents through the Internet, or compact disk, as means of distribution. Because of the lack of high-value content, and the inconvenience involved, consumers do not enthusiastically subscribe to the digital file, and these providers are not, currently, commercial successes.

In the future, book contents will incorporate videos and become large files. For instance, when school begins, tens of millions of people will need to download many large files simultaneously through the Internet. The sudden excess demand on the infrastructure of the Internet will inevitably lead to complications. The repeated transmission of large files through the Internet, anyway, will be an unnecessary waste of network resource and may be impractical.

On consideration of these shortcomings, the inventor proposed a convenient and practical solution to provide a copy right protecting digital publishing system.

### SUMMARY OF THE INVENTION

The invention is a digital publishing system that protects copy rights against piracy. The system includes:

A DigiReader, DGR, a device containing a decryption chip for display of contents;

A DigiBookstore, DGB, a server for storage and downloading of encrypted contents, built specifically for bookstores;

A PubNetmanager, PNM, a network service center that manages the encryption codes.

A DigiGuard, DGG, encryption/decryption hardware for publishers.

The system uses the encryption/decryption technologies developed for the financial industries for copy right protection, and is in compliance with the existing business flow involving the publishers, bookstores and consumers.

To the consumers, the system provides a device, DGR, which is of the same size and weight of a paper book and is a more capable vehicle (can carry sound and dynamic graphics . . . ). With exchangeable memory card the device has essentially limitless capacity for contents, thus, spreading the cost over many book contents. Similar to paper books, only one device can display a paid content.

To the authors and publishers, the contents are encrypted, with DGG, once they leave the publisher's database. Only the device that carries the correct decryption chip, supplied at the manufacturing factory, can decipher and display the content. Neither the bookstore nor the network service center can have access to the content. The content cannot be reproduced or deciphered by any computer. The system prevents piracy, thus, encourages publisher adoption for high-value content.

To the bookstore, the system provides for a mechanism for both the primary market, selling contents to consumers by publishers and secondary market, buying and selling of used content.

The secondary market mechanism is not available through the Internet download of content to computer ebook mode.

The system reduces consumption of paper, thus trees, and is friendly to the environment.

### BRIEF DESCRIPTION OF THE DRAWINGS

The drawings disclose an illustrative embodiment of the present invention which serves to exemplify the various advantages and objects hereof, and are as follows:

FIG. 1 is the operational flow chart of the present invention;

FIG. 1A is the interactive flow between the publisher and the PubNetmanager;

FIG. 1B is the interactive flow between the publisher and the DigiBookstore;

FIG. 1C is the interactive flow between bookstore and consumer;

FIG. 1D is the flow when buyer uses DigiReader to access the content;

FIG. 2 is the structure of DigiReader;

FIG. 3 is the structure of DigiBookstore;

FIG. 4 is the structure of PubNetmanager;

FIG. 5 is the structure of DigiGuard;

FIG. 6 is the operational flow chart of the secondary market.

### DETAILED DESCRIPTION OF THE PREFERRED EMBODIMENT

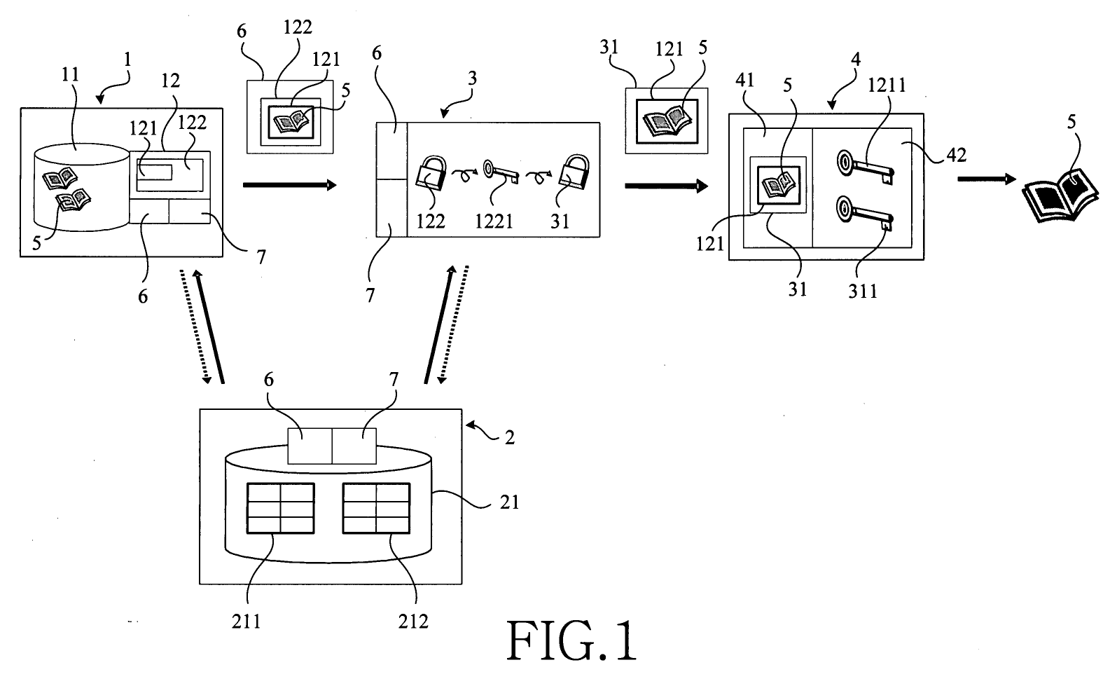

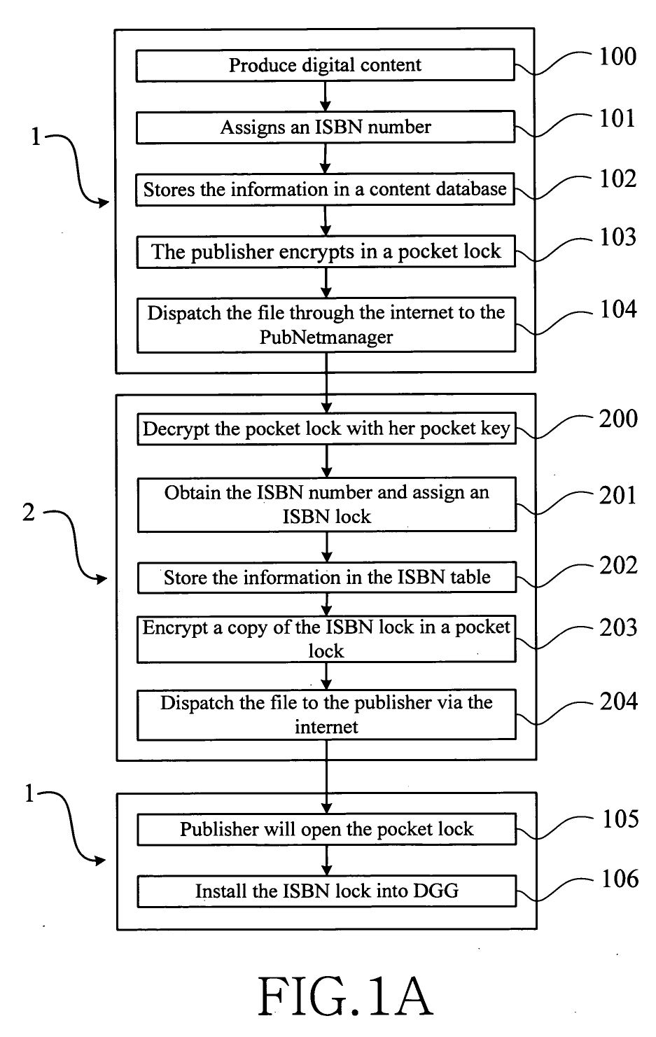

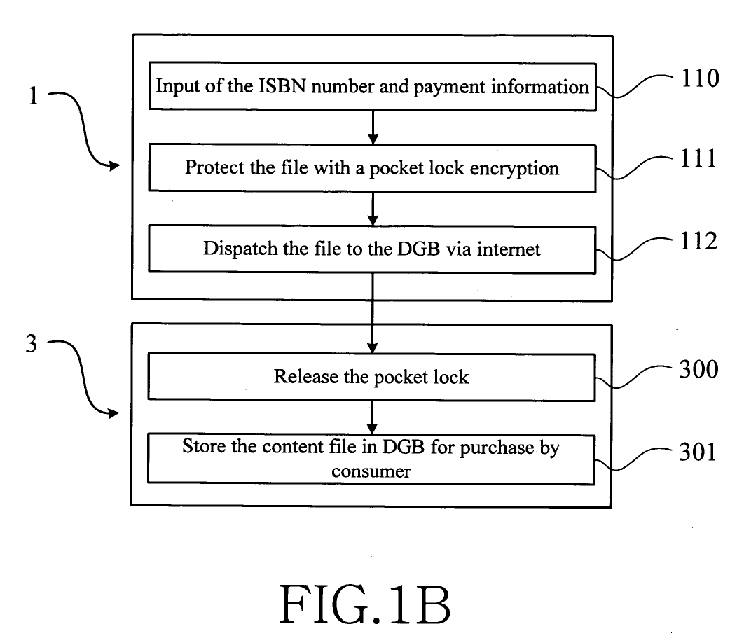

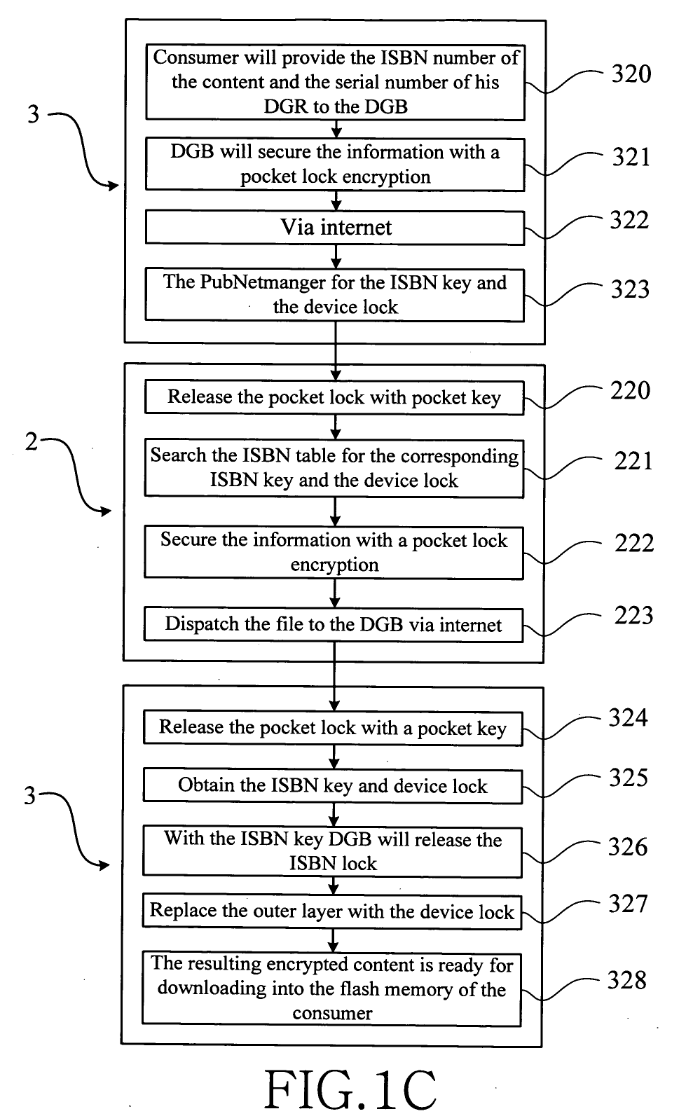

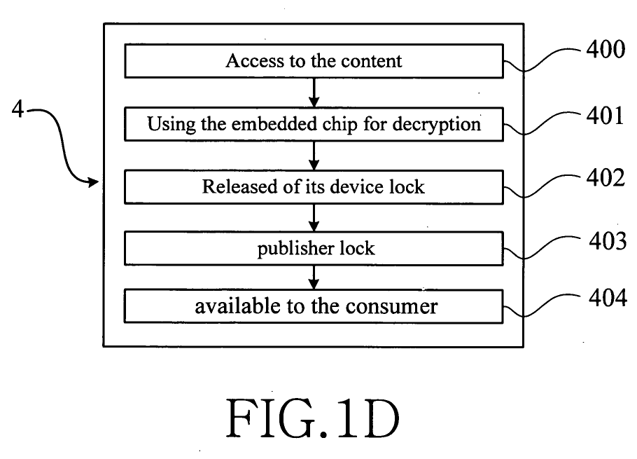

As depicted in FIG. 1, publisher 1 has a database 11, and a DGG 12. Database 11 holds the content 5. DGG 12 is a hardware that allows the publisher 1 to encrypt/decrypt data. The encryption mechanism of 12 has two layers, the inner layer lock 121 and the outer layer lock 122.

Publisher 1 always uses the pocket lock 6 and pocket key 7 for encryption/decryption when sending or receiving messages through the Internet.

The Network Manager is a network service center that supports a database 21 containing an ISBN table 211 and a device serial number table 212. The network service center 2 assigns an ISBN lock when presented with a novel ISBN by the publisher and keep the record in table 211. The PubNetmanager 2 also obtains the device lock 31 and key 311 from the device manufacturer and keeps the record in table 212.

The PubNetmanager 2 also uses pocket lock 6 and pocket key 7 for encryption/decryption when sending or receiving messages from the Internet.

DigiBookstore, DGB 3 is a specialty server designed for bookstores. It can store encrypted digital contents 5 from the publisher 1 for sale to consumers. When a consumer buys a digital content 5, DGB can relay the ISBN and device serial numbers, provided by the buyer, to the PubNetmanager 2 and request the ISBN key 1221 and the device lock 31.

DGB always uses pocket lock 6 and key 7 for encryption/decryption to protect transmitted files when using the Internet to communicate.

Upon receipt of the ISBN key 1221 and device lock 31, DGB will release the ISBN lock and replace the encryption with device lock 31 for the content 5. Content 5, thus encrypted, are ready for download by the consumer.

DigiReader, DGR 4 is a device built for the consumer to decrypt the encrypted content 5 and display the information. DGR 4 has a flash memory 41 and a decryption chip 42. The flash memory is for the storage of content 5 downloaded from the DGB 3 and the decryption chip 42 contains a specific device key 311 and the publisher key 1211 for device lock 31 and publisher lock 121.

FIG. 1A illustrates the interactive flow between the publisher and the PubNetmanager.

Publisher 1, when publishing a content 5, produces digital content 100 and assigns an ISBN number 101, and stores the information in a content database 102. The publisher encrypts in a pocket lock 103 and dispatch the file through the Internet to the PubNetmanager 104.

PubNetmanager 2 will decrypt the pocket lock with her pocket key 200 to obtain the ISBN number and assign an ISBN lock 201 to the number, and store the information in the ISBN table 202. The PubNetmanager 2 will also encrypt a copy of the ISBN lock in a pocket lock 203 and dispatch the file to the publisher via the Internet 204.

Upon receipt of the package from the PubNetmanager the publisherwill open the pocket lock 105, and install the ISBN lock into DGG106. DGG 12 has a two layer structure; the inner layer, the publisher lock 121, comes preinstalled by the manufacturer and the outer layer is the ISBN lock 122.

FIG. 1B illustrates the interactive flow between the publisher 1 and the DigiBookstore.

Before sending the digital content 5 to the bookstore 3, publisher 1 will secure the content with the DGG 12 encryption facility and, after the input of the ISBN number and payment information 110, protect the file with a pocket lock encryption 111 and then will dispatch the file to the DGBvia Internet 112.

Upon receipt of the file, bookstore 3 will release the pocket lock 300 and store the content file in DGB for purchase by consumer 301.

FIG. 1C illustrates the interactive flow between bookstore and consumer.

Buying content 5, consumer will provide the ISBN number of the content and the serial number of his DGR to the DGB 320. DGB will secure the information with a pocket lock encryption 321 and request, via Internet 322, the PubNetmanager 2 for the ISBN key and the device lock 323.

PubNetmanager 2, upon receipt of the file, will release the pocket lock with pocket key 220 and search the ISBN table for the corresponding ISBN key and the device lock 221. Retrieving both, PubNetmanager 2 will secure the information with a pocket lock encryption 222 and send the file, via Internet, to the DGB 223.

DGB 3, upon receipt of the file, will release the pocket lock with a pocket key 324, and obtain the ISBN key and device lock 325. With the ISBN key, DGB will release the ISBN lock 326 and replace the outer layer with the device lock 327. The resulting encrypted content is ready for downloading into the flash memory of the consumer 328. (Flash memory 41 can be either replaceable or embedded.) FIG. 1D illustrates the flow when buyer uses DGR to access the content.

Consumer places his flash memory 41 into the device, DGR 4, for access to the content 400 using the embedded chip for decryption 401. The content 5, encrypted with the inner publisher lock 121 and the outer device lock 122, is released of its device lock 402 and, then, of its publisher lock 403 and becomes available to the consumer 404. Other devices 4 or computers cannot access nor copy the content.

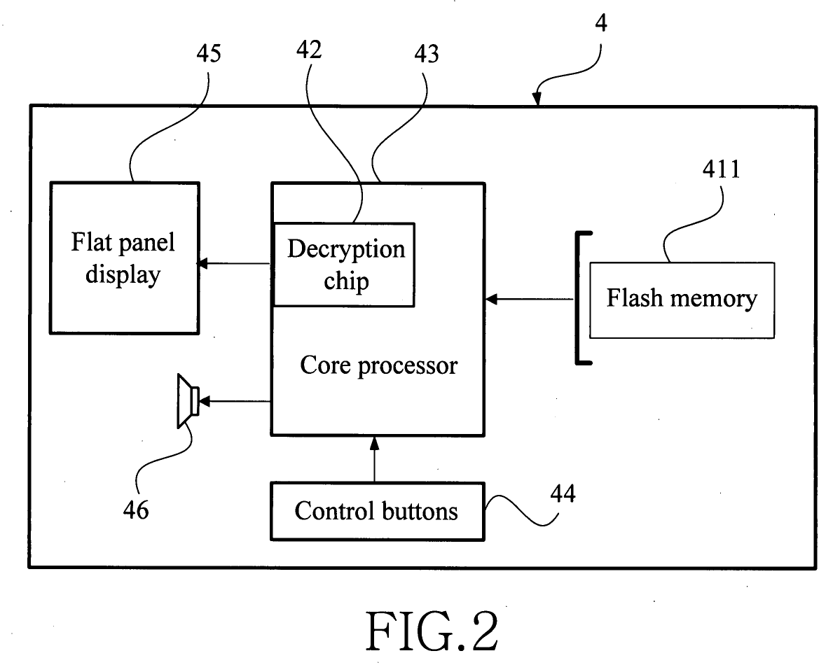

FIG. 2 illustrates a DigiReader, a device 4 with a core processor and a decryption chip. The device shall contain, in the minimum;

a cradle for flash memory 411, using a proprietary interface, DigiPub, for access to the content in the flash memory;

a decryption chip 42 with a two layer structure, the inner key being publisher key and the outer layer being the device key. The decryption uses Matryoshka architecture, a layered structure;

a core processor 43, capable of processing the digital content codes into image, sound, video, and, after decryption, for display;

control buttons 44; allow users to choose the functions of device 4;

a flat panel display 45, for the display of decrypted content; and

a speaker, for the sound from the decrypted content.

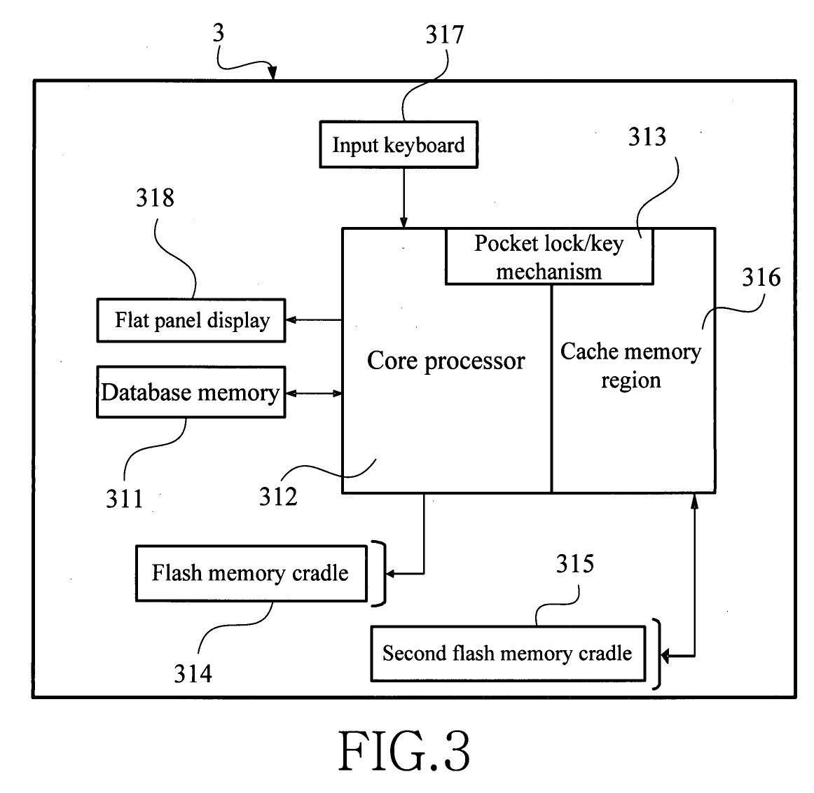

FIG. 3 illustrates the DigiBookstore 3, a specialty server built for bookstores capable of storing encrypted digital content. The server contains, in the minimum;

database memory 311, with a database containing the encrypted digital content from publishers;

a core processor 312, processing the receiving and storing of the digital content and other information from publishers;

a pocket lock/key mechanism, for the automatic encryption/ decryption of files when using the Internet;

a flash memory cradle 314, using a proprietary DG Pub interface, for the downloading of digital contents into flash memories equipped with the same interface;

a second flash memory cradle 315, using the proprietary DG Pub interface, for the downloading/deletion of digital content files in the flash memory in the secondary market;

a cache memory region 316, for the temporary storage of digital contents in the secondary market;

an input keyboard 317, allowing input of data; and

a flat panel display 318, for the display of input and/or received information.

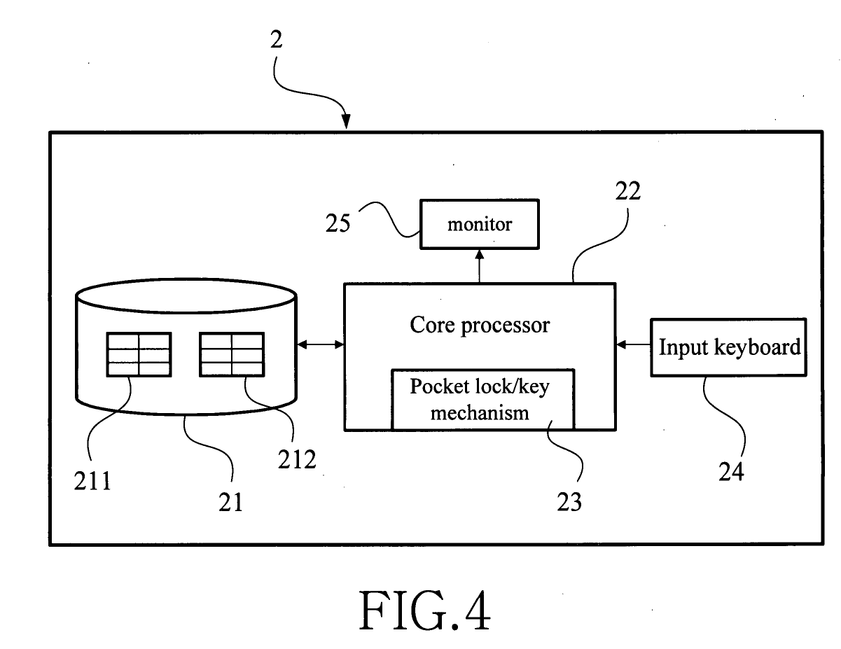

FIG. 4 illustrates the network service center operating PubNetmanager 2. The service center can manage the information concerning the devices and the content ISBN numbers. The center contains, in the minimum;

a network manager database 21, storing the ISBN number table 211 and the device serial number table 212;

a core processor 22, for the processing of the data concerning the device and the content ISBN;

a pocket lock/key mechanism 23, for the encryption/decryption of files transmitted through the Internet;

an input keyboard 24, for the operators to input information; and

a monitor 25, for the display of received/input information.

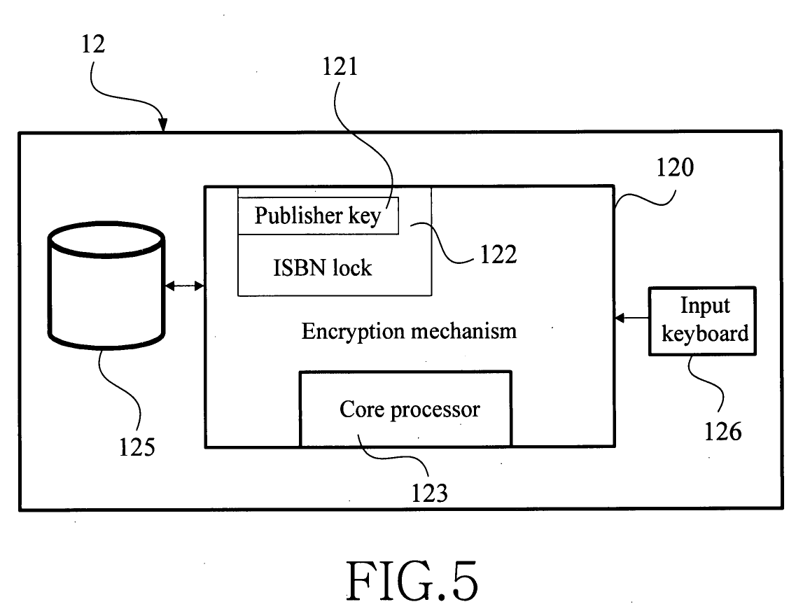

FIG. 5 illustrates DigiGuard, a hardware device for the publishers to encrypt/decrypt. The device contains, in minimum;

an encryption mechanism 120, which uses Matryoshka (one inside another) type encryption method, with the publisher key 121 being the inner key;

a core processor 123, for the processing of information including the requesting of ISBN lock 122 to be the outer layer lock and the encryption of digital content:

a pocket lock/key mechanism 124, for encryption/decryption of files to be transmitted through the Internet; and

an input keyboard 126, that allow the operators to input commands.

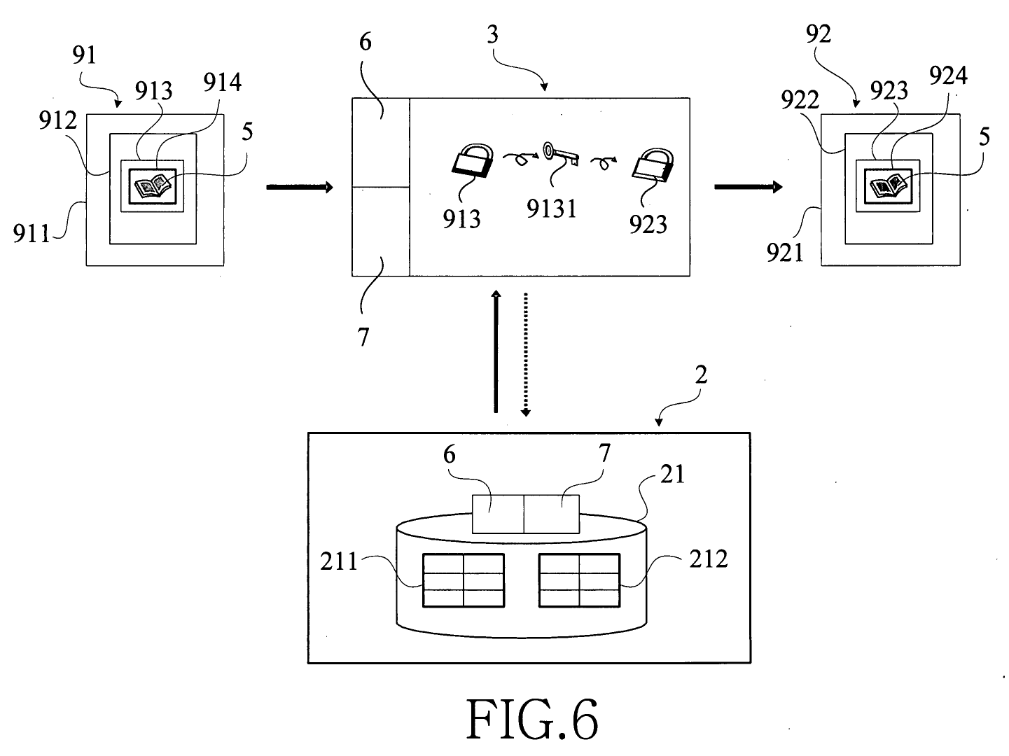

FIG. 6 illustrates the operational flow of the secondary market.

If there are seller and buyer, the transaction in the secondary market can be carried out with DigiBookstore 3. During the transaction, the seller's device lock on the digital content needs to be replaced with the buyer's device lock to allow access to the digital content 5 by the buyer. The following describes the process:

Seller 91 of digital content 5 places the flash memory 912 of his device 911 onto the specific cradle of DGB 3 and input the serial number of his device and the ISBN number of the content 5 into the cache memory region of DGB 3.

DGB 3 will relay the information to the network service center and request for the device key 9131 of the seller and the buyer's device lock 923, as well as the price and other information. The file will be secured with a pocket lock 6 before transmission over the Internet.

Upon receipt of the file, PubNetmanager 2 will release the pocket lock 6 with her pocket key 7 and obtain the ISBN number and device number, with which to search for the price and other information corresponding to the ISBN number from the ISBN table 211, and for the seller's device key 8131 and buyer's device lock 923 from the device serial number table 212. PubNetmanager 2 will secure the price and other information and seller's device key 9131 and buyer's device lock 923 with a pocket lock and dispatch the file to the DGB 3 via Internet.

Upon receipt of the file, DGB 3 will release the pocket lock 6 with pocket key 7 and obtain the seller's device key 9131 and buyer's device lock 923. DGB will, then use seller's device key 9131 to release seller's device lock 913 and replace it with buyer's device lock 923. The digital content can, then, be downloaded into the flash memory 922 of the device 921 of the buyer 92.

Buyer 92 can now display the content with his device 921. The decryption chip of his device will release the buyer's device lock 923 and the publisher lock 924 to make available digital content 5, which he bought from the secondary market. (Seller and buyer's publisher keys are identical and needs no replacement.)

If bookstore 3 is interested in a transaction even if seller 91 cannot find a buyer 92 temporarily, the bookstore can transplant the content into one of its own device with the aforementioned mechanism. When a buyer 92 is found, the same mechanism can be used to transplant the content into buyer's device 921.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A copy right protecting digital publishing system that proceeds in following steps:
Step 1, Publisher produces digital contents, assign ISBN number and store content in content database;
Step 2, Publisher will secure the ISBN number with a pocket lock and dispatch the information through Internet to the network service center operating PubNetmanager, PNM;
Step 3, Network service center, upon receipt of the file, will release the pocket lock with pocket key and obtain the ISBN number, The center will assign an ISBN lock corresponding to the number and store the information in the ISBN table of the database;
Step 4, Network center will secure a copy of the ISBN lock in a pocket lock and send the file back to the publisher;
Step 5, Publisher, upon receipt of the file, will release the pocket lock with pocket key, and, after obtaining the ISBN lock, install the lock into the DigiGuard, DGG; DGG has a two layer encryption structure; the inner layer being the publisher lock that comes from the manufacturer, and the outer layer being the ISBN lock;
Step 6, Publisher will encrypt digital content with the two layer encryption device of DGG, input ISBN number, price and other (payment) information, and, then, secure the file with the pocket lock before dispatching it to DigiBookstore, DGB;
Step 7, DigiBookstore, upon receipt of the file, will release the pocket lock with the pocket key, and store the digital content in DGB for sale to consumers;
Step 8, Consumer, wishing to buy content, will provide DGB with the ISBN number and the serial number of his device; DGB, based on the information will request network service center for the outer layer ISBN key and the device lock of the consumer device; The Internet transmitted information are secured and released with pocket lock/key;
Step 9, Network service center, upon receipt of the file, will search for the ISBN key from the ISBN table and the device serial number table for the device lock; The service center will send the information back to the DGB; Internet transmission is secured and release by pocket lock/key;
Step 10, DGB, on receipt of the file, will release the pocket lock with pocket key and obtain the ISBN key and the device lock; DGB will release the ISBN lock and replace it with the device lock of consumer, and download the encrypted content into the flash memory of the device of consumer;
Step 11, The decryption chip embedded in the device of consumer allows consumer to access the content; Other devices or computer will not be able to access the content nor duplicate it;
A copy-right protecting digital publishing system based on the concept of providing consumer with a single function device, protected from computer virus by avoiding connection to the Internet, and downloading of content strictly from a specialty server provided to the bookstore, thus a service mechanism for the bookstores in the digital publishing space; The system prevents piracy and encourages publishers to offer digital content to consumer and, in the end benefits consumers by making available convenient, low cost and high value digital content.

2. A copy right protecting digital publishing system that includes, in minimum, the following:
a DigiReader, DGR, a device for display of content;
a DigiBookstore, DGB, a specialty server designed for bookstores, for storage of bookstore digital content;
a Network Service Center operating PubNetmanager, a service center for the management of device serial number and corresponding information, as well as for the management of ISBN number and corresponding information; and
a DigiGuard, DGG, a hardware device for encryption /decryption for publishers;
Use of DGR, DGB, DGB and network service center, in compliance with current publishing business flow and eco-system, can protect intellectual property rights of authors and publishers and prevent piracy.

3. A copy right protecting digital publishing system, as covered in claim 2, in which DGR contains, in minimum:
a flash memory cradle, equipped with the proprietary DG Pub interface, for access to the digital content in the memory;
a core processor, for processing of the memory data into image, sound, video;
a decryption chip, with an inner and outer two layer structure;
control buttons, for control of device functions by user;
a flat panel display, for the display of contents; and
a speaker, for sound output.

4. A copy right protecting digital publishing system, as covered in claim 2, in which DGB contains, in minimum:
a database installation, for storage of encrypted content;
pocket lock/key mechanism, for encryption/decryption of files for transmission over the Internet;
a core processor, for processing of receipt of digital contents and other information from publishers and their storage according to ISBN numbers, as well as for message handling;
a flash memory cradle with a proprietary DG Pub interface, for downloading of stored digital content in database;
a second flash memory cradle with proprietary DG Pub interface, for deletion/upload/download of secondary market digital files;
a cache memory region, for temporary storage of digital content involved in the secondary market;
an input keyboard, for input of command by user; and
a flat panel display, for display of input and received information.

5. A copy right protecting digital publishing system, as covered in claim 2, in which the network service center contains, in minimum:
a network management database installation, for storing of information concerning the device serial number and ISBN numbers;
a core processor, for processing of stored information and for message handling;
a pocket lock/key mechanism, for encryption/decryption of files transmitted over the Internet;
an input keyboard, for input of commands; and
a display monitor, for the display of input/received information.

6. A copy right protecting digital publishing system, as covered in claim 2, in which the DigiGuard contains, in minimum:
an encryption chip, with embedded publisher lock as the inner layer and an outer layer for insertion of another lock;
a core processor, for encryption of digital content and for message handling;
a pocket lock/key chip, for encryption/decryption of files during transmission over Internet; and
an input keyboard for input of commands.

7. A copy right protecting digital publishing system, as covered in claim 3, in which the DGR decryption chip has layered structure, Matryoshka.

8. A copy right protecting digital publishing system, as covered in claim 3, in which the decryption inner layer, in the chip embedded in DGR, is the publisher key, installed by the manufacturer.

9. A copy right protecting digital publishing system, as covered in claim 3, in which the decryption outer layer is the device key, installed by the manufacturer, in the chip embedded in DGR.

10. A copy right protecting digital publishing system, as covered in claim 6, in which the DGG encryption mechanism has layered structure, Matryoshka.

11. A copy right protecting digital publishing system, as covered in claim 6, in which the inner layer encryption is the publisher lock installed by the manufacturer, in the chip embedded in DGG.

12. A copy right protecting digital publishing system, as covered in claim 6, in which the encryption outer layer, to be inserted, in the encryption chip embedded in DGG, is for the ISBN lock.

13. A copy right protecting digital publishing system, the procedure for secondary market is:
Step 1, Seller places his DGR flash memory into the secondary-market-cradle and inputs his device serial number, buyer's device serial number, and the ISBN number of the content into DGB;
Step 2, DGB will secure the seller and buyer DGR serial numbers and the ISBN number in the pocket lock and, via Internet, send to the network service center;
Step 3, Network service center, upon receipt of the file, will release the information from pocket lock with a pocket key; Network service center will search the ISBN table for the price and other information and will search the device serial number table for the seller device key and buyer's device lock;
Step 4, Network service center will secure the seller device key, buyer device lock, price and other information with a pocket lock and will send the file, via Internet, to the DGB;
Step 5, DGB, upon receipt of the file, will release the pocket lock with a pocket key and obtain the seller device key and buyer device lock;
Step 6, DGB will, with the help of seller device key, release the content file from seller device lock and replace it with buyer device lock;
Step 7, DGB will download the encrypted digital content into the flash memory of the buyer DGR and erase the file from the seller flash memory;
Step 8, Buyer DGR, equipped with the decryption chip can now access the digital content from the secondary market.
